(19) United States
(12) Patent Application Publication
(10) Pub. No.: US 2025/0381922 A1
(43) Pub. Date: Dec. 18, 2025

(54) CARGO BOX MEASURING SYSTEM

(71) Applicant: Toyota Motor Engineering & Manufacturing North America, Inc., Plano, TX (US)

(72) Inventors: Ryan C. Harris, Saline, MI (US); Scott Louis Frederick, Brighton, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/745,300

(22) Filed: Jun. 17, 2024

(51) Int. Cl. B60R 11/06; B60R 11/00; G01B 3/08

(52) U.S. Cl. CPC B60R 11/06; G01B 3/08; B60R 2011/004; B60R 2011/0075

(57) ABSTRACT

A cargo box measurement system described herein provides integrated measuring capability at a vehicle. In one embodiment, the cargo box measurement system includes a cover disposed over and attached to a surface of a sidewall panel of a cargo box of a vehicle. The cover includes a channel 1) formed in a cover surface that faces the sidewall panel and 2) that extends inward from an edge of the cover. The cargo box measurement system also includes a ruler slidably positioned within the channel and between the cover and the sidewall panel. The ruler is extendable from the channel away from the sidewall panel and the cover.

### TECHNICAL FIELD

The subject matter described herein relates, in general, to vehicle cargo boxes and more specifically, to cargo boxes with rulers formed in covers of the side panels of the vehicle cargo box.

### BACKGROUND

Some vehicles, which may be referred to as pickup trucks, include an open cargo space (i.e., a cargo box) behind a cab. Vertical side walls and a vertical front wall (i.e., adjacent to the pickup truck cab) rise from the cargo box surface. A tailgate, which pivotally opens and closes, forms a fourth wall of the cargo box. When an individual lowers the tailgate, they can load cargo into the cargo box. The tailgate is then raised to prevent the cargo from sliding out of the cargo box during transit. This cargo box provides ample space for cargo that may otherwise be impossible or difficult to transport in a non-truck-type vehicle. These pickup trucks may be used on construction sites, where construction workers load and store construction equipment in the cargo box.

### SUMMARY

In one embodiment, example cargo box measurement systems with rulers slidably positioned within a sidewall panel of the cargo box. In one embodiment, the cargo box measurement system includes a cover disposed over and attached to a surface of a sidewall panel of a cargo box of a vehicle. The cover includes a channel 1) formed in a surface that faces the sidewall panel and 2) that extends inward from an edge of the cover. The cargo box measurement system includes a ruler slidably positioned within the channel between the cover and the sidewall panel. The ruler is extendable from the channel away from the sidewall panel and the cover.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B illustrate one embodiment of a cargo box measurement system with a slidable and removable ruler formed in a tailgate of the cargo box.

FIG. 2 illustrates an extendable ruler of a cargo box measurement system.

FIG. 3 illustrates the extendable ruler removed from the cargo box.

FIG. 4 illustrates a cross-sectional view of the cargo box measurement system with the slidable and removable ruler.

FIG. 5 illustrates one embodiment of the cargo box measurement system implemented on a decktop protector of the cargo box.

### DETAILED DESCRIPTION

The cargo box measurement system of the present specification improves the utility of cargo boxes of pickup trucks. As previously described, pickup trucks include cargo boxes behind the cab. The cargo box provides a large open-topped area that can hold large quantities of objects or large objects. In an example, the pickup truck is used on construction sites to transport large items such as building supplies, construction tools, and the like. When working on a construction site, a construction worker may utilize the tailgate of the cargo box as a flat work surface. For example, the construction worker may lay a piece of lumber on the tailgate, with an end of the piece of lumber extending off one end. The extending end of the lumber may then be cut to length as the construction project dictates.

The flat surface of the tailgate may be used in other scenarios. For example, a user may lower the tailgate and use it as a table surface, for example to eat lunch outdoors or to rest recreational equipment (such as a kayak or fishing equipment, for example).

The measurement system of the present application enhances the utility of the flat surface of the tailgate by incorporating a measuring system into the tailgate. For example, as described above, whether a commercial or residential project, the flat surface of the tailgate may be used as a support for a construction project. In one example, before cutting the lumber, the construction worker may measure the piece of material, mark the material at a desired cut position, and cut the material at the mark. Accordingly, the construction worker may carry a small measuring device to mark the desired position for the cut on the material. However, it may be the case that such small measuring devices may be forgotten. Moreover, using a separate measuring device may complicate measuring and cutting as the user has to manage the separate measuring device and position and place the separate measuring tape across the material. While seemingly a minor consideration, using a non-integrated measuring device may complicate the construction operation. As another example, a user may spontaneously desire to measure an object. In this case, the user may not have brought a personal measuring tape to measure the object.

To facilitate these material-type and other measuring operations and simplify their execution, the cargo box of the present specification includes a ruler or measurement system integrated into the cargo box. Specifically, the cargo box measurement system of the present application includes a measuring device (i.e., a ruler) that extends from a vehicle tailgate or decktop protector and is removable from the vehicle tailgate.

Specifically, the tailgate may be formed of a metallic panel that defines its shape and dimensions. A plastic or resin cover, sometimes referred to as a tailgate service hole cover, is disposed over and attached to the metallic panel. The cover includes a channel that extends inward from a lateral edge. The cargo box measurement system includes a ruler that is extendable from this channel. Specifically, the ruler extends laterally from a side of the tailgate. In a stowed position, the ruler is within the boundaries of the tailgate, and the tailgate may be raised and lowered without any hindrance from the ruler. As desired, the ruler may be extended laterally. That is, the ruler may be extended in a width-wise direction perpendicular to the pickup truck's longitudinal direction. In an example, the ruler is made of a rigid material that may be cantilevered from the pickup truck tailgate. That is, the ruler may freely hang, being simply supported at one end.

The ruler includes measurement indicia such as molded markings by which a user can measure the length of an object (e.g., material for a construction project, objects used for recreation such as fishing line, etc.). The ruler may include imperial (e.g., inches and feet) and/or metric measurements (e.g., millimeters, centimeters, meters).

In one example, the panel cover (i.e., the service hole cover or the decktop protector) includes measurement demarcations. Measurement indicia on the cover help measure objects that are shorter or as long as the tailgate width but may not be able to facilitate the measurement of objects longer than the width of the tailgate. Accordingly, by providing measurement indicia that extend beyond the cargo box tailgate, the present cargo box measurement system provides additional measuring capabilities beyond the width of the tailgate.

In an example, the ruler has a hooked tab on the end that can facilitate sliding the ruler out of the channel, and that may also be used as a material stop. That is, when stowed, the finger tab may extend upward from the base of the ruler above the height of the cover. Accordingly, a user may grasp the hooked finger tab and extend the ruler laterally.

In one example, the ruler may be removable from the channel so that a user may measure objects away from the vehicle. For example, a construction worker may remove the ruler and carry it to the work site to measure the length of objects away from the vehicle. The ruler may then be returned to and stowed in the vehicle tailgate.

In an example, the cargo box measurement system may include multiple extendable and removable rulers. For example, one extendable ruler may laterally extend and be removable from a first side (e.g., passenger side) of the tailgate while a second extendable ruler may laterally extend and be removable from a second side (e.g., a driver side) of the tailgate.

As described above, the ruler may extend out of a lowered tailgate. In another example, the cover may be formed over a top surface of a non-lowering cargo box sidewall, such as a sidewall that forms a lateral side of the cargo box. In this example, the lateral sidewall also includes a plastic or resin cover, which may be referred to as a decktop protector. In this example, the channel is formed in the plastic or resin cover, and the ruler extends from the plastic or resin decktop protector. In this example, rather than extend laterally in a widthwise direction, the ruler may extend along a longitudinal direction of the pickup truck.

In either case, the disclosed cargo box measurement system is integrated into the cargo box such that a user may measure the length of any object at the truck side, even those objects that are longer than the width of the cargo box. The integration of a measurement system into the vehicle ensures that at all times, a user may be able to measure the length of any object, even when a personal measuring device is unavailable, forgotten, or otherwise not considered.

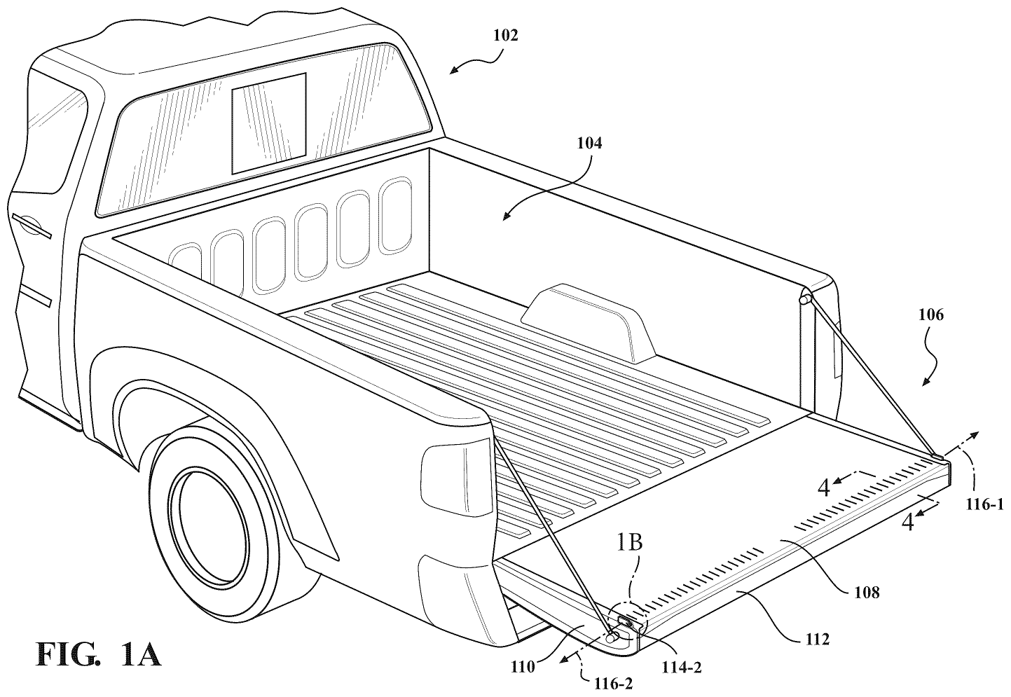

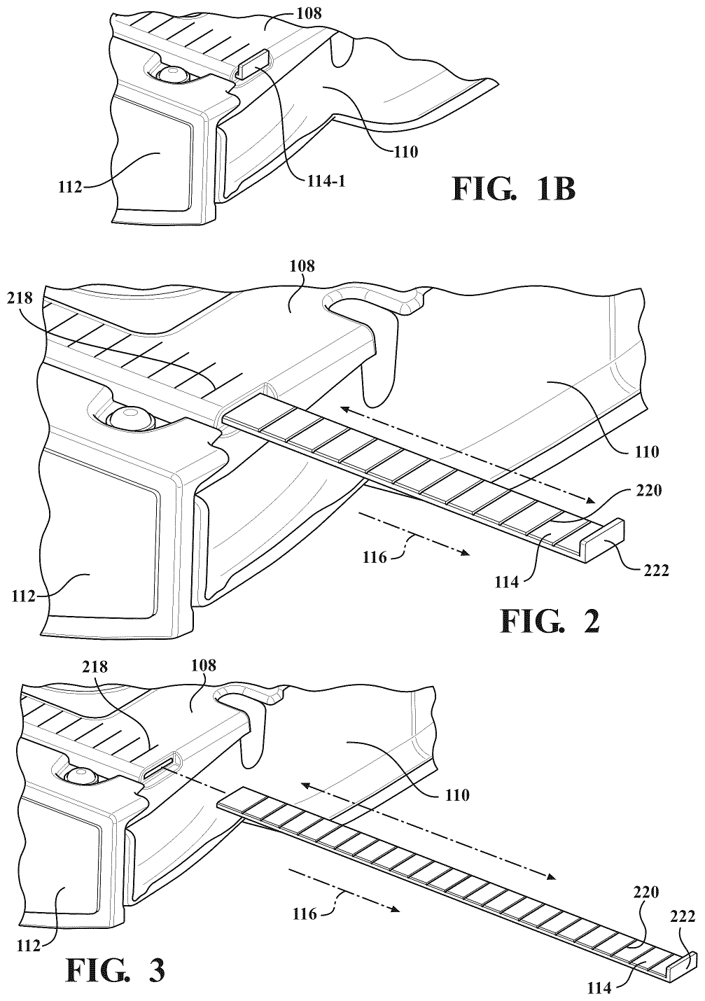

Turning now to the figures, FIGS. 1A and 1B illustrate one embodiment of a cargo box measurement system with a slidable and removable ruler 114, with FIG. 1B depicting a zoomed in view of the indicated portion of FIG. 1A. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

As described above, trucks are vehicles 100 with a cargo box 104 that can hold and haul large cargo and/or large quantities of cargo. The cargo box 104 generally includes a flat floor with lateral side walls extending vertically from the floor and a front wall extending vertically from the floor. A tailgate 106 of the truck may be pivotally attached to the lateral side walls and transition between a closed position where the tailgate 106 is vertical and an opened position where the tailgate 106 is horizontal. During hauling, the tailgate 106 is raised to form a fourth wall of the cargo box 104. With the tailgate 106 raised, the cargo, which may be secured with ropes, straps, tie-downs, or covers, may be easily transported. When lowered, the tailgate 106 is horizontal and aligns with the floor of the cargo box 104. As described above, the tailgate 106 may be used as a work surface or table in this lowered position. For example, construction materials or other objects may be placed on the flat horizontal tailgate 106.

As such, the cargo box 104 is formed of various sidewall panels, one of which is a tailgate 106 that is pivotally lowered and raised. The tailgate panel 110 may be generally rectangular and defines the shape of the tailgate 106. In an example, the tailgate panel 110 may be formed of any rigid material such as a metallic material such as sheet metal or aluminum. However, the tailgate panel may be formed of other materials.

In some examples, a cover 108, sometimes referred to as a tailgate service hole cover, is disposed over and attached to the surface of one of the sidewall panels of the cargo box 104. Specifically as depicted in FIGS. 1A and 1B, the cover 108 may be disposed over and attached to a box-facing surface of the tailgate panel 110, with the box-facing surface being defined as that surface that faces the cargo box 104 when in the raised position. The cover 108 may be formed of any material, such as plastic or resin, which may provide a more aesthetically pleasing surface and be more user-friendly. Moreover, a plastic or resin cover 108 may be less likely to scratch or damage the object (e.g., construction material) placed thereon and provides a protective surface that may be more easily replaced than a metallic interior panel of a vehicle when damaged.

The top surface of the tailgate panel 110 may be covered by a top cap 112, which protects the top surface of the tailgate panel 110, the top surface being defined as the most vertical surface of the tailgate 106 when in a raised/closed position. Like the cover 108, the top cap may be formed of any material such as plastic or resin.

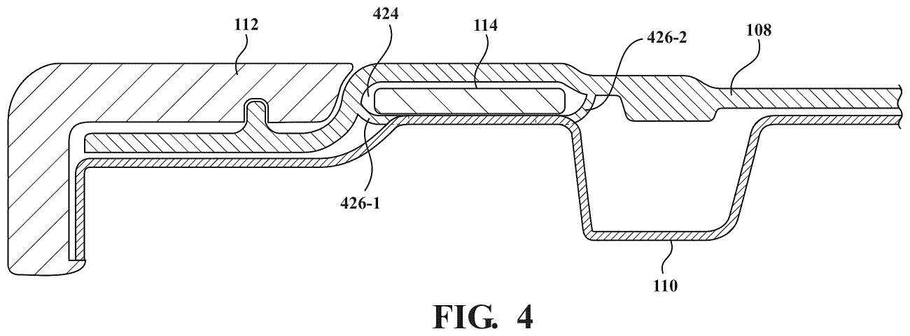

As described herein, the cargo box measurement system may be formed on the tailgate 106 portion of the cargo box 104. Specifically, as depicted in FIGS. 1A and 1B, the sidewall panel over which the cover 108 is disposed may be the tailgate panel 110 pivotally connected to adjacent sidewall panels of the cargo box 104. In another example, such as that depicted in FIG. 4, the cover in which the cargo box measurement system is disposed is a decktop protector on the top surface of a cargo box side panel.

As depicted in FIG. 4 below, the cover 108 includes a channel formed in a surface that faces the sidewall panel (e.g., the tailgate panel 110). That is, as depicted in FIG. 4, the channel is not open to the box-facing surface of the cover 108 but rather is open to the panel-facing surface. The channel extends inward from a lateral edge of the cover 108. That is, the channel is open on the lateral side of the cover 108. A ruler 114 is inserted into and extended from this channel. As depicted in FIGS. 1A and 1B, the channel may be formed at a distal end of the cover 108 away from the cargo box 104. Doing so may facilitate the facile measurement of long materials. In an example, the channel may have a length that matches or is greater than the length of the ruler 114 that is inserted therein. Additional details regarding the structure and form of the channel are provided below in connection with FIG. 4.

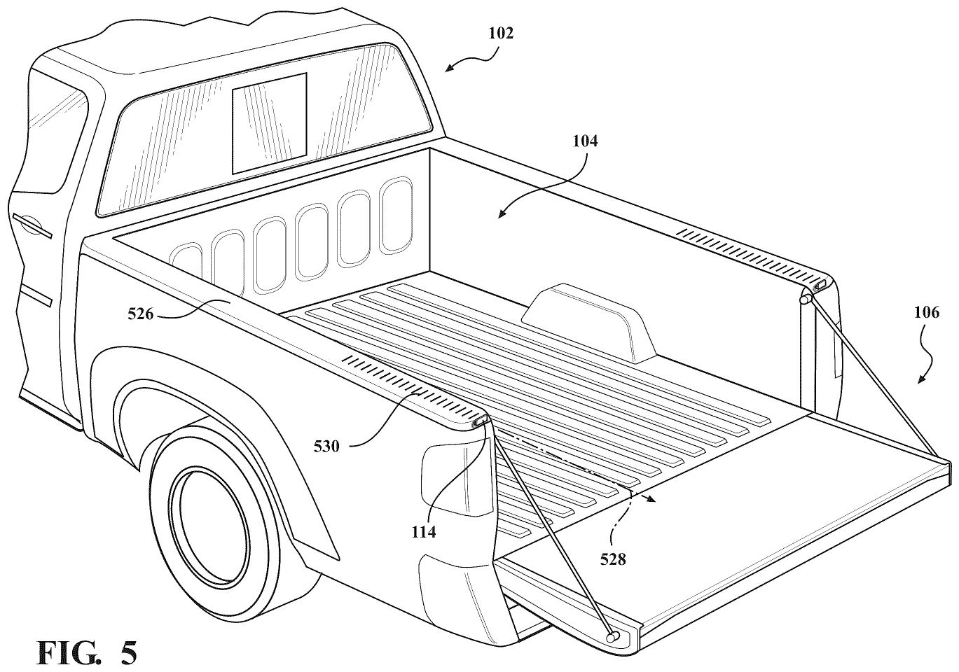

The cargo box measurement system also includes a ruler 114, slidably positioned within the channel and between the cover 108 and the sidewall panel. In general, the ruler 114 is laterally extendable from the channel and away from the sidewall panel and the cover 108. In the example where the cargo box measurement system is formed on a tailgate 106 of the cargo box 104, the ruler 114 is extendable laterally away from the tailgate 106 and the cover 108, as depicted in FIG. 2. That is, as depicted in FIG. 2, the ruler 114 may extend laterally away from the vehicle 102 in a vehicle width-wise direction. In other examples, the cargo box measurement system may be formed in other panel covers of the cargo box 104, such as on a decktop protector of a sidewall panel of the cargo box 104 as depicted in FIG. 5. FIG. 1A depicts two rulers 114-1 and 114-2 extendable from either lateral side of the tailgate 106. In an example, the indicators *-1 and *-2 indicate specific instances of an element, while the lack of such an indicator references a general instance of the element.

The ruler 114 may be made of any material, such as sheet metal, aluminum, plastic, or a polymer material. As depicted in FIG. 2, the ruler 114 may include measurement indicia thereon such that a user may measure the length of materials, such as construction materials to be cut to length or other objects. As the ruler 114 is extendable away from the lateral edge of the tailgate 106, the ruler 114 provides a longer measurement surface than measurement indicia on the tailgate 106 alone. That is, the tailgate 106 has a predetermined width, and any measurement indicia formed thereon would be limited to measuring materials that are shorter than, or equal to, the width of the tailgate 106. Via the extendable ruler 114, objects of greater length may be measured.

In an example, the cargo box measurement system may include one or more extendable rulers 114. For example, a first extendable ruler 114-1 may be extendable laterally away from the tailgate 106 and the cover 108 in a first lateral direction 116-1. The cargo box measurement system may include a second ruler 114-2 slidably positioned within the channel or a different channel and between the cover 108 and the sidewall panel (e.g., the tailgate 106). This second ruler 114-2 is extendable away from the sidewall panel (e.g., the tailgate 106) and the cover 108 in a second lateral direction 116-2 that is opposite the first lateral direction 116-1. As such, a user may use either ruler 114-1 and 114-2 (collectively referred to as 114) or both the rulers 114-1 and 114-2 at the same time to measure long materials.

As such, the cargo box measurement system of the present specification facilitates the measuring of materials that may be longer than a cargo box tailgate 106. Specifically, the measurement may be via an integrated system, so the user does not have to rely on a separate measurement system or the management of such to measure the long material.

FIG. 2 illustrates an extended ruler 114 of a cargo box measurement system. Specifically, FIG. 2 depicts the extension of a single ruler 114 from one side of a tailgate cover 108. As described above, the ruler 114 may be extendable laterally away from the tailgate 106 and cover 108 in a lateral direction 116, where a lateral direction is defined as a direction perpendicular to the longitudinal axis of the vehicle 102. To facilitate the extension of the ruler 114, the ruler 114 may include a hooked tab 222 at the distal end of the ruler 114. The hooked tab 222 may extend vertically away from and perpendicular to the body of the ruler 114. The height of the hooked tab 222 may be greater than the height of the cover 108. The hooked tab 222 may reside outside the channel when the ruler 114 is stowed and may extend above the height of the cover 108. Accordingly, to extend the ruler 114, a user may grasp the hooked tab 222 and pull in a lateral direction 116. The hooked tab 222 may also form a material stop when measuring an object.

In an example, the friction between the ruler 114 and the interior walls of the channel may provide resistance to movement. Accordingly, a user may push a material against the hooked tab 222, and the hooked tab 222 may remain in place so long as the force of the material against the hooked tab 222 does not overcome the friction force between the ruler 114 and the channel walls. To stow or extend the ruler 114, or to change the length of the ruler 114 to expose additional measurement indicia, the user may exert a translational force in the first lateral direction 116-1 or a second lateral direction 116-2 to a degree to overcome this friction force. The resistance provided by the frictional force provides some stability to the ruler 114 and prevents nominal forces from causing the ruler 114 to retract or extend. If friction forces are too low, the ruler 114 may retract and extend inadvertently, which may be a nuisance.

FIG. 2 also depicts the measurement indicia 220 that may be formed on the ruler 114. The measurement indicia 220 may take a variety of forms. For example, the measurement indicia may be printed on or molded into a plastic/resin ruler 114. In another example, the measurement indicia are etched into a metal ruler 114. In another example, the measurement indicia 220 may be printed on an adhesive paper that is affixed to the ruler 114. While particular reference is made to particular types of measurement indicia 220, the ruler measurement indicia may be formed on the ruler 114 in many ways.

In an example, measurement indicia 218 may be formed on the cover 108 into which the ruler 114 is inserted. The ruler measurement indicia 220 may sequentially continue from the measurement indicia 218 formed on the cover 108 or may be independent of such. As an example, given the case where the cover measurement indicia 218 extend across the width of the tailgate 106, the highest value of such measurement indicia 218 may be 48 inches when using imperial units given the typical sizes of a tailgate 106. In an example, the ruler 114 extends from a lateral side of the tailgate 106 on which the largest cover measurement indicia 218 value is formed. In this example, the first measurement value on the ruler 114 (i.e., the measurement closest to the largest measurement indicia on the tailgate 106 (48 inches in this example) when the ruler 114 is fully extended) may be 49 inches. Ruler measurement indicia 220 values may increase along the length of the ruler 114. In this example, the largest ruler measurement indicia 220 value may be the indicia closest to the hooked tab 222, which largest value may be based on the length of the ruler 114.

In another example, the ruler measurement indicia 220 may be independent of the cover measurement indicia 218. In this example, the ruler measurement indicia 220 do not continue the numbering of the cover measurement indicia 218. Given a largest cover measurement indicia 218 value of 48 inches, the smallest value of the ruler measurement indicia 220 (e.g., 1 inch) may be adjacent to the hooked tab 222 with the measurement indicia values increasing along a length of the ruler 114 towards the tailgate when the ruler 114 is extended. In this example, the largest ruler measurement indicia 220 value may be that indicia closest to the tailgate 106, which largest value may be based on the length of the ruler 114.

In this example, a user may determine the length of an object by combining cover measurement indicia 218 values and ruler measurement indicia 220 values. For example, suppose a construction worker wants to cut a piece of lumber to 60 inches. Given a cover measurement indicia 218 largest value of 48 inches, the user may extend the ruler 114 laterally until the measurement indicia of 12 inches (i.e., 48 inches plus 12 inches) is exposed. In this example, the user may abut the material against the hooked tab 222. The user may then cut the lumber at the opposite end of the tailgate 106, thus resulting in a piece of lumber that is 60 inches long.

While particular reference is made to a ruler 114 that extends from a portion of the tailgate cover 108 that is associated with the largest measurement value, in another example, the ruler 114 may extend from a lateral side of the cover 108 that has the smallest cover measurement indicia 218 value (e.g., 0 inches). Moreover, while particular reference is made to imperial-based measurement indicia 218 and 220, the cover 108 and ruler 114 may include metric indicia or both imperial and metric indicia.

The length of the ruler 114 may be based on the number of rulers 114 housed within the cover 108 and the number of ruler-housing channels. For example, given a tailgate width of 48 inches and a single ruler 114 integrated into a single channel, the maximum length of the ruler 114 may be 48 inches. In another example, given a tailgate width of 48 inches and two rulers 114-1 and 114-2 extending out either side of the same channel, the maximum length of each ruler 114-1 and 114-2 may be 24 inches. However, in another example, the cargo box measurement system may include two channels, each housing a separate ruler 114-1 and 114-2. In this example, given a tailgate width of 49 inches, the maximum length of each ruler 114-1 and 114-2 in the separate channels may be 48 inches. While particular examples are provided for lengths of the rulers 114-1 and 114-2, the rulers 114-1 and 114-2 may be any length so long as the ruler 114 fits within a tailgate-defined channel.

FIG. 3 illustrates an extended ruler 114 removed from the cargo box 104. In addition to being extendable, the ruler 114 may be entirely removed from the cargo box 104, such that a user may take the ruler 114 to a remote location for measurement purposes. That is to say, the ruler 114 is removable from the channel. To do so, a user continues to extend the ruler 114 in the lateral direction 116 until the ruler 114 is completely removed from the channel. Following use, the user may re-insert the ruler 114 into the channel for stowage and transport.

FIG. 4 illustrates a cross-sectional view of the cargo box measurement system with the slidable and removable ruler 114. Specifically, FIG. 4 depicts a cross-section taken along the line 4-4 in FIG. 1A. FIG. 4 depicts the top cap 112 and cover 108 that are disposed over and attached to the tailgate panel 110.

FIG. 4 also clearly depicts the channel 424, which is formed on the surface of the cover 108 that faces the tailgate panel 110 and in which the ruler 114 is stowed. In an example, the channel 424 is a three-sided channel with interior walls adjacent to the top surface and side surfaces of the ruler 114. As such, as described above, the channel 424 is open to the tailgate panel 110. A three-sided channel 424, however, may not fully support the ruler 114 as the ruler 114 may slide laterally within the channel 424 without support along its bottom surface. Accordingly, the channel 424 may include at least one of 1) longitudinally-spaced tabs 426-1 and 426-2 that extend from the sidewalls of the channel 424 underneath the bottom surface of the ruler 114 and 2) channel-length lips that extend from the sidewalls of the channel underneath the bottom surface of the ruler 114. In this example, the longitudinal direction of the ruler 114 may be into the page. Accordingly, at predetermined positions along this longitudinal direction, tabs 426-1 and 426-2 may extend below the bottom surface of the ruler 114 to ensure that the ruler 114 remains in the channel 424 when stowed. These tabs 426-1 and 426-2 also support the ruler 114 when extended. That is, when in the extended position, the ruler 114 may tend to wobble or sag. These tabs 426-1 and 426-2 may hold the ruler 114 tight against the cover 108.

In another example, channel-length lips may extend the whole longitudinal length of the channel 424 and may similarly retain the ruler 114 in place. In an example, channel-length lips, as opposed to longitudinally spaced tabs, may provide greater frictional resistance to the extension and retraction of the ruler 114 within the channel 424. Accordingly, tabs or lips may be implemented based on a desired friction force to retain the ruler 114 in place, whether wholly or partially extended or seated within the channel 424.

FIG. 5 illustrates one embodiment of the cargo box measurement system implemented on a decktop protector 526 of the cargo box 104. As described above, the cargo box measurement system may be implemented on any surface of the cargo box 104. For example, decktops, or top surfaces of sidewalls of the cargo box 104 may similarly be protected, in this example, by a decktop protector 526. Similar to the cover 108, the decktop protector 526 may be formed of a plastic or resin material and may be positioned over and attached to the surface of a sidewall panel of the cargo box 104. In this particular example, the cover (i.e., the decktop protector 526) is disposed over and attached to a top surface, or deck, of the sidewall panel. Similar to the cover 108, the decktop protector 526 includes a channel 424 that is open to a panel-facing surface. In this example, rather than extending inward from a lateral edge (e.g., in a width-wise direction), the channel extends inward from a distal edge of the cover, with the distal edge defined as that edge farthest away from the cab of the vehicle 102. Put another way, a ruler 114 in a tailgate portion of the cargo box 104 extends laterally from the tailgate panel 110, while a ruler 114 in a decktop protector 526 extends longitudinally away from the panel as indicated by the arrow 528. As with the cover 108, in an example, the decktop protector 526 includes measurement indicia 530, which may be in metric units, imperial units, or both metric and imperial units. In either example, the ruler 114 may include measurement indicia, as depicted in FIG. 2, that either sequentially continue from the decktop protector measurement indicia 530 or are independent of such.

The ruler 114 formed within the channel of the decktop protector 526 may be the same as the ruler 114 described above in that it includes measurement indicia 220 and a hooked tab 222 that facilitates the extension and stowage of the ruler 114. Moreover, the channel in the decktop protector 526 may be similar to the channel 424 depicted in FIG. 4. Specifically, the decktop protector channel may be a three-sided channel with longitudinally-spaced tabs or whole-length lips to retain the ruler 114 in place during stowage and to support the ruler 114 while extended.

As such, the cargo box measurement system provides a tool integrated into the vehicle cargo box 104 to provide on-site and facile measurement of objects, even those that are longer than the width of the tailgate 106 of the vehicle 102.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A cargo box measurement system, comprising:
a cover disposed over and attached to a surface of a sidewall panel of a cargo box of a vehicle, the cover comprising a channel:
formed in a cover surface that faces the sidewall panel; and
that extends inward from an edge of the cover; and
a ruler slidably positioned within the channel and between the cover and the sidewall panel, the ruler is extendable from the channel away from the sidewall panel and the cover.

2. The cargo box measurement system of claim 1, wherein:
the sidewall panel is a tailgate pivotally connected to adjacent sidewall panels of the cargo box;
the cover is disposed over and attached to a box-facing surface of the tailgate;
the channel extends inward from a lateral edge of the cover; and
the ruler is extendable laterally away from the tailgate and the cover.

3. The cargo box measurement system of claim 2, wherein the channel is positioned at a distal end of the cover away from the cargo box.

4. The cargo box measurement system of claim 2:
wherein the ruler is extendable laterally away from the tailgate and the cover in a first lateral direction; and
the cargo box measurement system further comprises a second ruler slidably positioned within the channel and between the cover and the sidewall panel, the second ruler is extendable from the channel away from the sidewall panel and the cover in a second lateral direction that is opposite the first lateral direction.

5. The cargo box measurement system of claim 1, wherein:
the cover is disposed over and attached to a top surface of the sidewall panel; and
the channel extends inward from a distal edge of the cover.

6. The cargo box measurement system of claim 1, wherein the ruler is removable from the channel.

7. The cargo box measurement system of claim 1, further comprising a hooked tab at a distal end of the ruler that extends out of the channel and above a height of the cover.

8. The cargo box measurement system of claim 1, wherein:
the channel is a three-sided channel with interior walls adjacent a top surface of the ruler and side surfaces of the ruler; and
the channel further comprises at least one of:
longitudinally-spaced tabs that extend from sidewalls of the channel underneath a bottom surface of the ruler; or
channel-length lips that extend from the sidewalls of the channel underneath the bottom surface of the ruler.

9. The cargo box measurement system of claim 1, further comprising measurement indicia formed on the cover, wherein ruler measurement indicia sequentially continue from the measurement indicia formed on the cover.

10. The cargo box measurement system of claim 1, further comprising measurement indicia formed on the cover, wherein ruler measurement indicia are independent from the measurement indicia formed on the cover.
